(19) United States
(12) Patent Application Publication
(10) Pub. No.: US 2024/0037520 A1
(43) Pub. Date: Feb. 1, 2024

(54) SECURE PAYMENT PLATFORM

(71) Applicants: Omar Ellison, Waxhaw, NC (US); Roumayah I. Tyler, Indian Trail, NC (US)

(72) Inventors: Omar Ellison, Waxhaw, NC (US); Roumayah I. Tyler, Indian Trail, NC (US)

(21) Appl. No.: 18/360,534

(22) Filed: Jul. 27, 2023

Related U.S. Application Data
(60) Provisional application No. 63/392,697, filed on Jul. 27, 2022.

(51) Int. Cl. G06Q 20/10; G06Q 20/38; G06Q 20/40

(52) U.S. Cl. CPC G06Q 20/10; G06Q 20/382; G06Q 20/388; G06Q 20/40145

(57) ABSTRACT

A transaction platform includes an originator device; a recipient device; a server comprising a processor, a memory storage device, and a non-transitory computer readable medium; and a network electronically connecting the originator device and the receiver device with the server. The processor performs a method coded as instructions on the non-transitory memory medium. The method includes registering an originator; authenticating the originator; registering a recipient; authenticating the recipient; receiving a transaction type selection including identifying the recipient; searching for the recipient; drawing funds from the originator; sending the funds to the recipient; autogenerating a payment validation routine to the originator device and the receiver device using criteria including geolocation; and receiving confirmation from the recipient of receipt of the funds.

### CROSS-REFERENCE TO RELATED APPLICATION

This application claims the benefit of priority of U.S. provisional application No. 63/392,697, filed Jul. 27, 2022, the contents of which are herein incorporated by reference.

### BACKGROUND OF THE INVENTION

The present invention relates to secure financial transactions and, more particularly, to a secure payment platform.

Fraud, scams, human error, and security failures result in a massive loss of money in the process of person-to-person payments. On a global level, fraudulent transactions, security issues and incorrect delivery of funds persist in the billions.

With prior art payment platform systems, once a person hits send, the funds are lost forever, with no protection from fraud, scams and/or human error.

As can be seen, there is a need for a means of authenticating the parties in a payment transaction.

### SUMMARY OF THE INVENTION

In one aspect of the present invention, a transaction platform includes an originator device; a recipient device; a server comprising a processor, a memory storage device, and a non-transitory computer readable medium; and a network electronically connecting the originator device and the receiver device with the server. The processor is operative to perform a method coded as instructions on the non-transitory memory medium, the method comprising the steps of: registering an originator; authenticating the originator; registering a recipient; authenticating the recipient; receiving a transaction type selection including identifying the recipient; searching for the recipient; drawing funds from the originator; sending the funds to the recipient; autogenerating a payment validation routine to the originator device and the receiver device using criteria including geolocation; and receiving confirmation from the recipient of receipt of the funds.

Cashbox closes the gap where banks will not. Cashbox may detect and reduce fraud, scams, and human errors. Cashbox locks the cash of businesses and consumers to keep their money secure and allows the user to securely send and receive funds. Whether transacting in person or online, the app provides a fool-proof way to make sure a sender's money goes to the correct person.

These and other features, aspects and advantages of the present invention will become better understood with reference to the following drawings, description, and claims.

### BRIEF DESCRIPTION OF THE DRAWINGS

FIGS. 1, 2, 3, 4, 5, 6, 7, 8, and 9 screenshots from a secure payment platform according to an embodiment of the present invention;

FIG. 10 is a flowchart of a method of using the secure payment platform according to an embodiment of the present invention; and

FIG. 11 is a system diagram of a ‘Virtual Safe’ according to an embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, one embodiment of the present invention is a system and method for securing peer-to-peer financial transactions.

The system generally includes a premier payment platform that facilitates payments between person-to-person (P2P), business-to-business (B2B), business-to-consumer (B2C), and consumer-to-business (C2B) utilizing a multifactor authentication process and tokenized transactions.

The inventive payment platform is sometimes referred to herein as “CASHBOX”, “CASHBOX”, “GHOSTBOX”, and “Cashbox”. Cashbox provides several exclusive features and capabilities that make it the top tool for addressing consumer needs.

The term “CASHBOX Virtual Safe” as used herein refers to multifactor authentication process where the funds are held in escrow prior to sending and being released to the end recipient. The Virtual Safe provides an advanced system and method for enhancing security and reducing risks associated with peer-to-peer (P2P) financial transactions. It specifically addresses the problem of erroneous transactions where users mistakenly send funds to unintended recipients, a limitation present in existing P2P platforms. It protects against fraud, scams, and loss of funds. The Virtual Safe′ feature leverages an escrow-like mechanism which temporarily holds funds during a transaction process. By doing so, it introduces a double authentication process, providing users an opportunity to confirm the transaction details before finalizing. It protects a sender's money before it is released to a peer, business, or total stranger through a marketplace. The Virtual Safe′ adds an extra layer of security to protect against scams. If a user receives a request for payment from someone who is not known or trusted by the user, the Virtual Safe′ can be used to hold the funds until the user has verified that the transaction is legitimate.

The process of the ‘Virtual Safe’ feature is as follows:
1. Transaction initiation: A user, herein referred to as the “sender”, initiates a financial transaction intending to transfer funds to another user, referred to as the “recipient”. The funds to be transferred are placed in a secure, virtual escrow account, termed the “virtual save”, rather than being directly transferred to the recipient's account.
2. Recipient notification and request: Once the funds are in the ‘Virtual Safe’, the system automatically notifies the intended recipient about the incoming transaction. The recipient is required to send a request tot the sender for the release of the funds.
3. Sender confirmation: Upon receipt of the request from the recipient, the sender receives a notification, presenting an opportunity to verify the recipient's identity and the transaction details. If the sender confirms that the details are correct, they can authorize the release of the funds from the ‘Virtual Safe’. If they find discrepancies, such as an incorrect recipient, they can decline the release of the funds.
4. Transaction completion or reversal: If the sender approves the release, the system completes the transaction by transferring the funds from the ‘Virtual Safe’ to the recipient's account. If the sender declines the release, the transaction is reversed, and the system returns the funds from the ‘Virtual Safe’ back to the sender's account.
This ‘Virtual Safe’ system and method offer significant advantages over existing P2P transaction systems by adding an additional layer of security to transactions. By giving users the chance to verify transaction details before finalizing, it reduces the risk of irreversible erroneous transactions, thereby improving overall user confidence and satisfaction in P2P financial transactions.

The term “GHOSTBOX” refers to an embodiment of the present invention that enables a sender to send money anonymously to a selected recipient whether the recipient is a person, business, charity, etc. When sending a gift or donation, the recipient receives a notification in their “Cashbox” app letting them know they've been “ghosted”. The recipient can then access the funds securely through their “Cashbox” wallet. For example, “GhostBox” can be used to send anonymous donations to those who are going through a tough time, such as illness or job loss. “GhostBox” can also be used to make anonymous donations to local charities and non-profits, supporting the community and making an impact. “GhostBox” transactions are generally secure and encrypted, ensuring that personal and financial information is protected. Encryption methods may be both symmetric and asymmetric. Additionally, transactions are generally processed through a secure payment gateway to prevent fraud or other security breaches.

The payment platform of the present subject matter clears authorization of a payment. Originator and receiver both register and authenticate themselves, validating their identities. The sender initiates payment and the inventive system autogenerates a payment validation routine to both sender and receiver using criteria including geolocation.

In some embodiments, the inventive system may support a CA$HBOX credit card or debit card.

In some embodiments, the inventive system may support check cashing.

In some embodiments, the inventive system may support investment.

In some embodiments, the inventive system may couple to existing banking systems and/or electronic agreement systems.

To use the CASHBOX system for marketplace selling and transactions, a user may select a transaction type, search for and add a recipient, send funds to the recipient, and await acknowledgement or confirmation from the recipient of receipt of funds. The sender may then exit the system.

The platform is generally a native app available for use on both IOS® and Android® operating systems. Buyers and sellers may use the system to exchange products, goods, or services and confirm receipt thereof before funds are released.

The inventive system (Cashbox) may be used as a “shell” in conjunction with existing payment networks, such as Zelle®, Venmo®, CashApp®, the United States Internal Revenue Service (IRS), the United States Department of Health and Human Services (DHHS), PayPal®, Western Union®, and Remitly®.

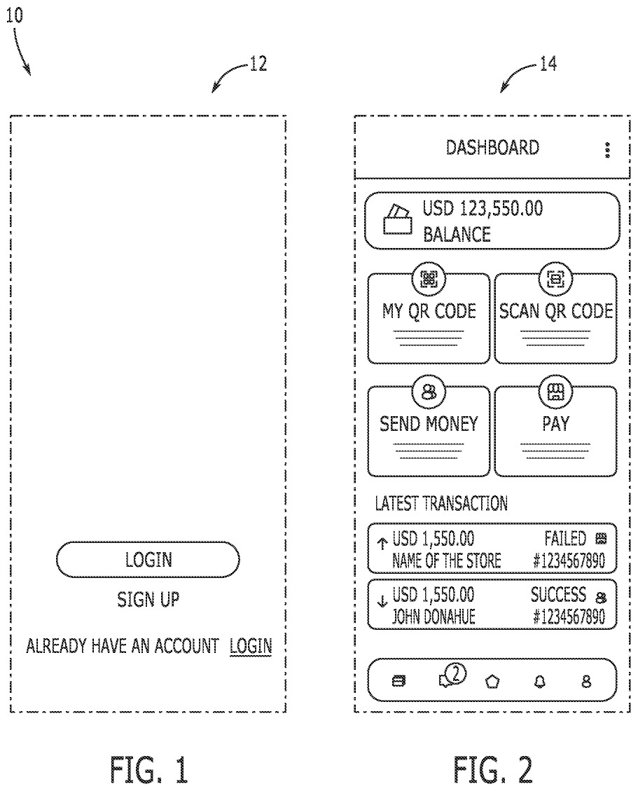

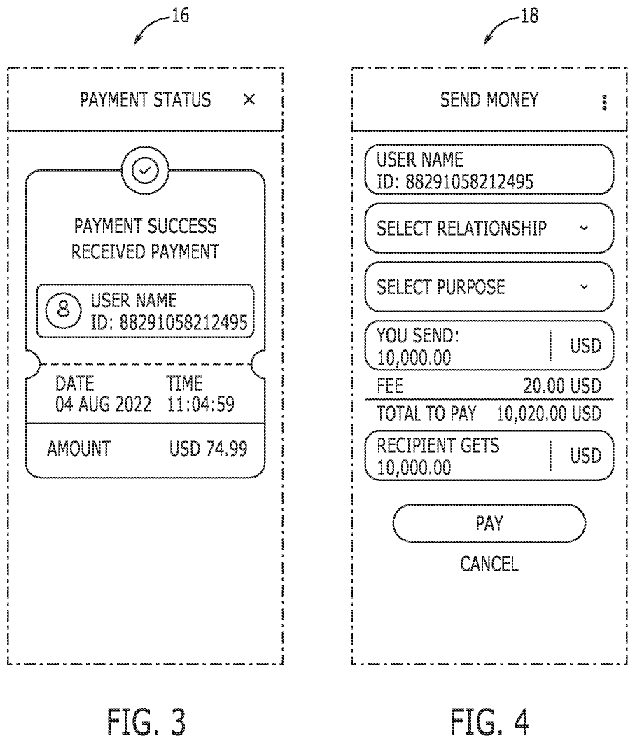

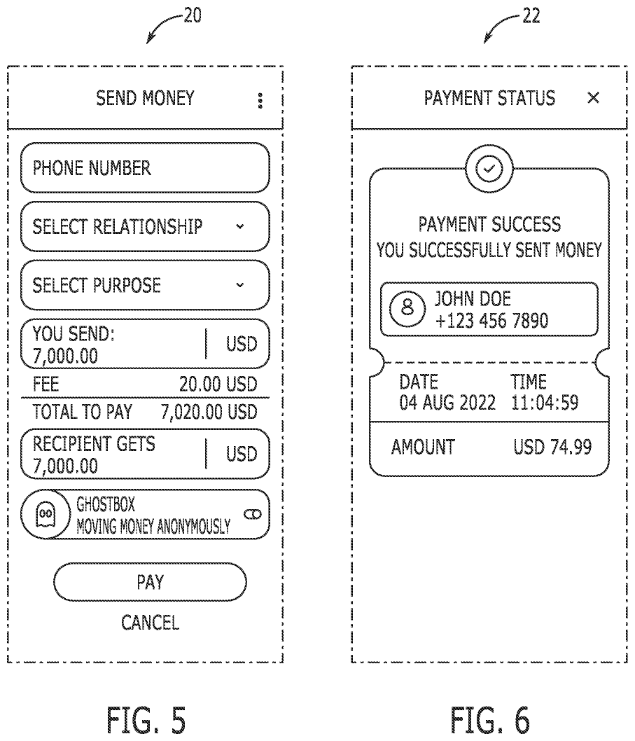

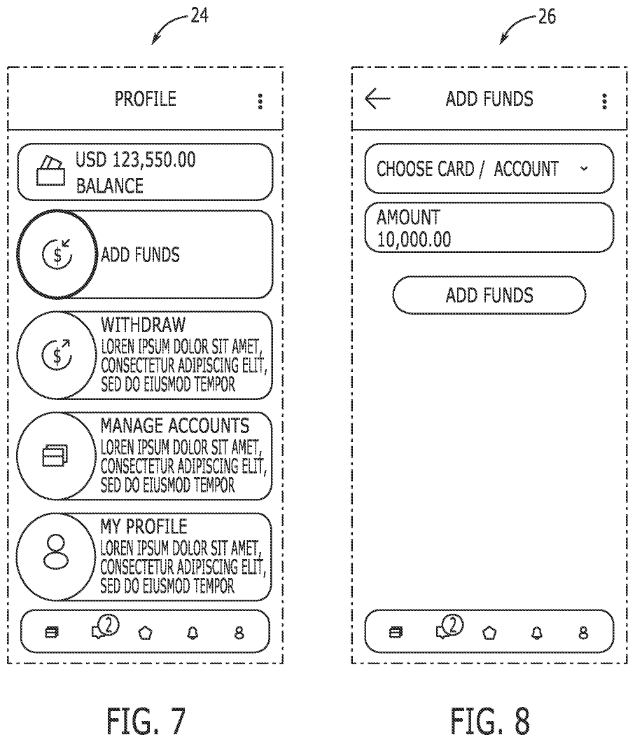

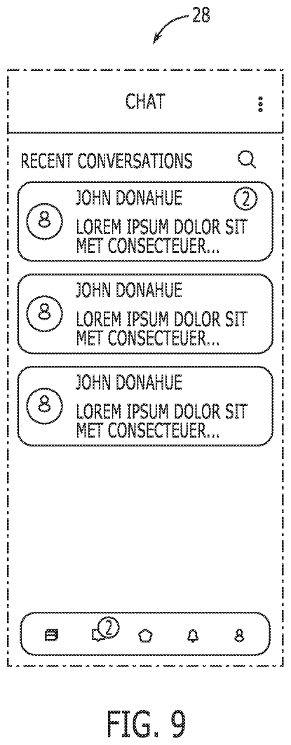

Referring to FIGS. 1 through 10, FIGS. 1 through 9 are screenshots of the application user interface used according to an embodiment of the present invention. Beginning with FIG. 1, a user may login 12 on a platform 10 to view a dashboard 14 shown in FIG. 2. As shown in FIG. 3, the user may view their payment status 16 before issuing their instructions 18; see FIG. 4. An alternate instruction 20 is shown in FIG. 5. Once the payment instructions 18, 20 are complete, the payment status 22 is displayed. The platform may further maintain a user profile 24, as shown in FIG. 7, from which the user may add funds 26; see FIG. 8. The platform may also support a chat 28 function between the users, as shown in FIG. 9.

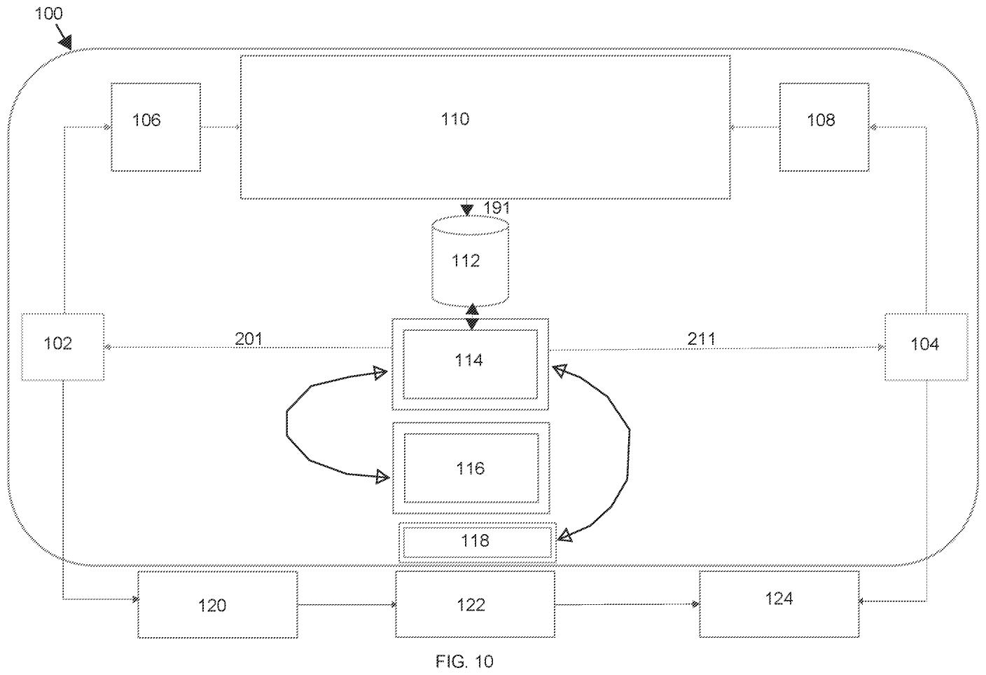

FIG. 10 provides a flowchart 100 for a user's 102, 104 enrollment on the inventive system and approval of a user's transaction. The user 102, 104 may be a sender, payor, document originator, receiver, payee, or document signer. To enroll 106, 108, the user 102, 104 must provide basic customer data 110, such as name, email, phone number, home address, and work address, which is captured 191 and stored in a database on a memory storage device 112. The system verifies the user's identity, including using email address and phone number. Verification may be performed based on geolocation, phone, email, and third-party identity verification sources such as Socure® or IDology®. The user 102, 104 may then make a card payment, provide biometric data to the system, complete challenge questions, enter a personal identification number (PIN) and passcode, and download the application programming interface (API) 118. Payment may be collected by credit or debit card information. In some cases, the system may rely on monthly auto renewal. Biometrics that may be captured by the system include voice, eyes, facial, and third-party data. The system may also capture out-of-pocket challenge questions, PIN, passcode, and/or a picture identification (ID).

The enrolled sender 102 may then make a transaction 120 by remitting funds which are debited from the sender's 102 account via a payment service 122, such as Zelle® or Venmo®. The API 118 call is triggered by last name, email, and phone number match. The sender 102 is notified by a push alert 201 with a request to confirm that the funds were sent. The sender 102 may login to the app 202, review, and if appropriate, approve the transaction, identify the nature/reason of the transfer, and select a challenge question for the receiver. The user may respond to a challenge question. Biometric, geolocation, PIN, and a risk score 116 for the bank in question (or pass/fail) may all be used to verify the transaction. If the sender 102 successfully responds to all inquiries, a transaction PIN may be issued. The receiver is then notified by a push alert 211 with a request to confirm he or she is expecting a payment. The receiver 104 may login to the app to review, and if appropriate, approve the transaction, identify the nature/reason of the transfer, and respond to the challenge question selected by the sender. In some cases, the system may require entry of a PIN provided by the sender. The system may also capture the receiver's geolocation to verify the transaction. If the receiver successfully responds to all inquiries, the funds are credited to the receiver 124 and the transaction is completed.

When the enrolled document originator submits a document through a digital signature service 122, such as Docusign®, the system notifies 201 the originator to confirm document submission, the nature of the document, and any other criteria to confirm the transmission. If the originator logs in and successfully responds to all inquiries, the signer receives a notification 211 to confirm that they are signing the document, the nature of the document, and any other criteria to confirm the transmission. If the receiver successfully responds to all inquiries and signs the document responsive to a digital signature request 124, the transmission is completed.

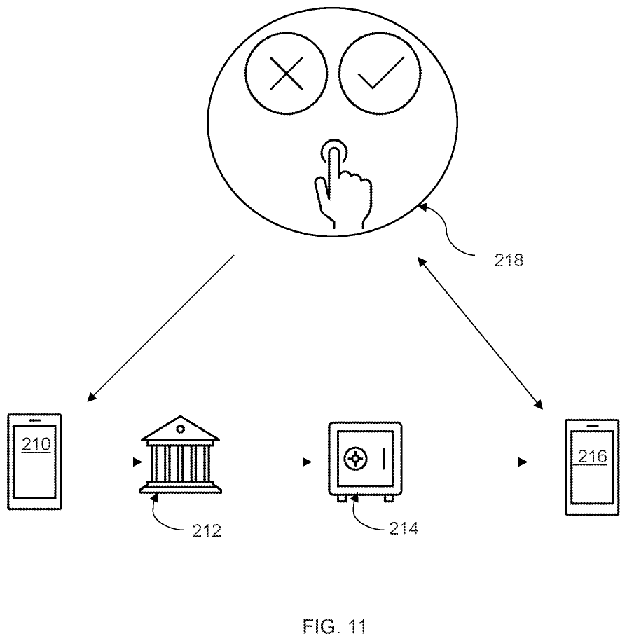

FIG. 11 illustrates operation of a Virtual Safe′ feature according to embodiments of the present invention. The sender 210 opens the App and sends funds via a selected transaction type. Funds are sent to a CASHBOX affiliate partner bank 212. The Virtual Safe′ 214 receives funds from the bank and assigns a unique transaction number. The recipient 216 receives an alert, then requests funds from the sender. If the sender refuses the transaction 218, the funds are returned to the sender. If the sender signs off 218, funds are sent to the recipient account in the CASHBOX App.

It should be understood, of course, that the foregoing relates to exemplary embodiments of the invention and that modifications may be made without departing from the spirit and scope of the invention as set forth in the following claims.

What is claimed is:

1. A transaction platform, comprising:
an originator device;
a recipient device;
a server comprising a processor, a memory storage device, and a non-transitory computer readable medium; and
a network electronically connecting the originator device and the recipient device with the server;
wherein the processor is operative to perform a method coded as instructions on the non-transitory computer readable medium, the method comprising the steps of:
registering an originator;
authenticating the originator;
registering a recipient;
authenticating the recipient;
receiving payment instructions from the originator including a transaction type selection and identifying the recipient;
searching for the recipient;
drawing funds from the originator;
holding the funds securely;
autogenerating a payment validation routine to the recipient device;
receiving a response from the recipient device;
transmitting the response to the originator device;
upon authorization by the originator, releasing the funds to the recipient;
receiving confirmation from the recipient of receipt of the funds; and
reporting the confirmation to the originator.

2. The transaction platform of claim 1, wherein the processor further maintains a user profile.

3. The transaction platform of claim 1, wherein the transaction platform enables a chat between the originator and the recipient.

4. A transaction method, comprising:
providing the transaction platform of claim 1;
registering an originator;
authenticating the originator;
registering a recipient;
authenticating the recipient;
receiving payment instructions from the originator including a transaction type selection and an identity of the recipient;
drawing funds from the originator;
holding the funds securely;
searching for the recipient;
autogenerating a payment validation routine to the recipient device;
receiving a response from the recipient device;
transmitting the response to the originator device;
upon authorization by the originator, releasing the funds to the recipient;
receiving confirmation from the recipient of receipt of the funds; and
reporting the confirmation to the originator.

5. The transaction method of claim 4, further comprising:
collecting a user's name, email, phone number, home address, and work address;
storing the user's name, email phone number home address, and work address in a database on the memory storage device; and
enrolling a user on the transaction platform;
wherein the user is the originator or the recipient.

6. The method of claim 5, further comprising:
verifying an identity of the user using two or more parameters selected from the group consisting of: last name; email address; phone number; geolocation; third-party identity verification sources; biometric data; and challenge questions; a personal identification number; a passcode; a picture identification; a risk score; and a nature of the payment; and
triggering an application programming interface (API) call.

7. The method of claim 6, wherein the biometric data is selected from the group consisting of: voice scan, eye scan, facial scan, and third-party data.

8. The method of claim 5, further comprising:
notifying the originator by a first push alert to review the payment and to confirm that the funds were sent; and
notifying the recipient by a second push alert to confirm expecting a payment.

9. The method of claim 5, further comprising:
collecting selection of a challenge question from the originator for the recipient.

10. A method of obtaining a document signature, comprising:
providing the transaction platform of claim 1;
registering an originator;
authenticating the originator;
registering a recipient;
authenticating the recipient;
receiving a document through a digital signature service and instructions including an identity of the recipient from the originator;
holding the document securely;
searching for the recipient;
autogenerating a transaction validation routine to the recipient device;
receiving a response from the recipient device;
transmitting the response to the originator device;
upon authorization by the originator, releasing the document to the recipient;
obtaining a signature from the recipient; and
confirming the signature; and
returning the document with the signature to the originator.
